(19) United States
(12) Patent Application Publication
(10) Pub. No.: US 2002/0140611 A1
(43) Pub. Date: Oct. 3, 2002

(54) Antenna arrangement

(75) Inventors: Per Ligander, Goteborg (SE); Leif Bergstedt, Sjomarken (SE); Ingmar Karlsson, Kallered (SE)

Correspondence Address: Stanley R. Moore, Esq., Jenkens and Gilchrist, P.C., 3200 Fountain Place, 1445 Ross Ave., Dallas, TX, 75202, US

(73) Assignee: Telefonaktiebolaget L M Ericsson (publ)

(21) Appl. No.: 10/107,704

(22) Filed: Mar. 27, 2002

(30) Foreign Application Priority Data
Mar. 30, 2001 (SE) 0101181-6

(51) Int. Cl. H01Q 1/38

(52) U.S. Cl. 343/700 MS

(57) ABSTRACT

An antenna arrangement includes a first portion and a second portion, each portion being arranged spaced apart and on first and second sides of at least one carrier structure. Each of said first and second portions includes at least one antenna element. The antenna elements of each antenna portion are electrically connected and the antenna element of said first portion is arranged to transmit an incident electromagnetic radiation on said first side of said carrier in form of an electrical signal to the antenna element of said second portion on said second side of said carrier. The antenna element of said second portion is arranged to transform and radiate the electrical signal from the second side of the carrier. Each antenna element comprises a thin layer of a conductive coating arranged on at least part of surface of said carrier.

### TECHNICAL FIELD OF THE INVENTION

The present invention relates to an antenna arrangement, preferably a passive antenna arrangement and specially an antenna arrangement of the type that comprises a first portion and a second portion. Each portion being arranged spaced apart and on first and second sides of at least one carrier structure. Each of said first and second portions comprising at least one antenna element. The antenna elements of each antenna portion is electrically connected and the antenna element of said first portion is arranged to transmit an incident electromagnetic radiation on said first side of said carrier in form of an electrical signal to the antenna element of said second portion on said second side of said carrier, which antenna element of said second portion is arranged to transform and radiate the electrical signal from the second side of the carrier.

The invention also relates to a method of manufacturing the antenna arrangement.

### BACKGROUND OF THE INVENTION

Excellent coverage indoors, is usually a problem for satellite transmissions and telecommunications. In particular, the growth of the telecommunications and especially cellular telecommunications has increased the need for smaller and more frequent cells, e.g. in GSM networks. The cells comprise base station antennas, which generally are provided on roofs, house fronts, masts etc., resulting in an unaesthetic appearance of the urban environment.

Thus, there is a need for a new type of antenna that fulfils the requirements for an effective antenna, provide invisibility and allow better coverage indoors. The antenna according to the invention dose not acquires any substantial space.

In JP 11 122023, the problem to be solved is to utilize the window glass of a building as a low altitude antenna installation method and to install a small-sized radio equipment indoors to be connected to indoor communication line and power supply line. Hence, an antenna transparent film provided with an antenna radiation circuit and a coupling element for feeding power is placed on the outer surface of the window glass. A reflector film provided with a circuit equivalent to a reflector on antenna characteristics and a coupling element for feeding power is s arranged, corresponding to the antenna transparent film on an inner surface side. The coupling element for feeding the power is capacitively coupled with the coupling element and feeds the power to this antenna. The coupling element for feeding the power and the radio equipment are connected through a feeder.

EP 608 180 relates to windows, especially compound windows, consisting of at least one sheet of a rigid material, permanently including a surface antenna consisting of at least one microstrip separated from an earth plane by a dielectric. These windows including such an antenna are used for reception and transmission of frequencies higher than 1 GHz, and preferably for the frequency bands 5795-5815 MHz, 63-64 GHz and 74-77 GHz.

Other less relevant windshield antennas are also known; see for example U.S. Pat. No. 5,714,959, U.S. Pat. No. 5,926,141, DE 4 420 903 and JP 8 242 115.

In EP 431 640 A2, a mobile cellular antenna system is described, which includes an auxiliary antenna that is coupled to a radiator on the exterior of a vehicle. This arrangement permits users or portable or transportable cellular telephones with built-in antennas to gain transmission and reception advantage from the exterior antenna while operating from within the passenger compartment.

European Patent Publication No. 429 203 relates to an antenna system for a vehicle and particularly for a radiotelephone. The system comprises a whip antenna fastened to the outside of the vehicle and receiving and/or transmitting signals. The antenna is in galvanic communication with the interior of the vehicle. Inside the vehicle there is an internal whip antenna connected galvanically to the external antenna. The radiotelephone includes a separate antenna of its own.

According to JP 61-285219, antennas are arranged on a base and are adhered onto an inner face of a window panel of floors or the like. Matching circuits are made of the film base and connected to a feeder. When a carrier of a sub set in one floor makes a call, a radio wave is radiated from an antenna to a space in the room. The radio wave is received by a first antenna, fed to the second antenna via a feeder and the matching device and radiated into the second floor as the radio wave. The radio wave is received by a second antenna of a main set, to a speaker or a telephone line, allowing the call with an external line.

JP 10-378352 describes an antenna device, in which radio waves received by a first antenna are guided through a cable, and the radio waves are transmitted from a second antenna so that radio waves can be satisfactorily transmitted and received in a fixed range within several tens of centimeters in the vicinity of the second antenna.

### SUMMARY OF THE INVENTION

Thus, the main object of the present invention is to provide an antenna, especially a passive antenna that provides better transmission into and out of an enclosed volume or a compartment.

Another object of the present invention is to provide a novel method of manufacturing an antenna arrangement according to the invention, especially on silicon-based carriers.

Therefore, in the initially mentioned antenna arrangement each antenna element comprises a thin layer of a conductive coating arranged on at least part of surface of said carrier.

In the most preferred embodiment, said carrier structure comprises at least two glasses in a two-glass window and the antenna elements are arranged on the surfaces of each glass. It is possible to control the radiation by providing each antenna element on each glass with different characteristics.

In another embodiment said carrier structure is glasses of a three-glass window. In this case, an intermediate glass is provided with a ground plane and inner and outer glasses are arranged with antenna elements.

Each antenna element can have a pattern, which can be adapted to a desired frequency. Also, the distance between the antenna parts is adapted such that a desired performance within an especial frequency band(s) is obtained.

The function of the antenna can be controlled by designing an externally arranged antenna element to direct an antenna lobe to a radiation source.

According to one aspect of the invention, the antenna elements are formed as a group antenna for providing increased amplification.

According to one embodiment, the antenna arrangement constitutes a Planar Inverted-F Antenna (PIFA), wherein one antenna element at one side of said carrier is arranged as a radiating element and another element at the other side of the carrier is arranged as a ground plane. This arrangement allows for powerful but yet simple antennas and also for multi-band antennas. In one embodiment the thin conductive layer is arranged as a microstrip. Specially but not exclusively, in window applications, at least one of said elements is substantially light preamble.

According to the invention a method of manufacturing an antenna element on a transparent carrier is provided, which comprises arranging a light permeable and conductive coating on said carrier, and arranging a galvanic connection to said coating. The coating is arranged with a shape or size by selective coating and/or by cutting out section by means of a laser beam. The coating can be provided through spraying or sputtering.

### BRIEF DESCRIPTION OF THE DRAWINGS

In the following, the invention will be further described in a non-limiting way with reference to the accompanying drawings in which:

FIG. 1 is a schematic perspective view of an antenna arrangement according to the first aspect of the invention,

FIG. 2 is a schematic perspective view of an antenna arrangement according to the second aspect of the invention,

FIG. 3 is a schematic cross-sectional view of an alternative embodiment according to the second aspect of the invention,

FIG. 4 is a schematic cross-sectional view of an antenna arrangement according to the third aspect of the invention,

FIG. 5 is a schematic perspective view of an antenna arrangement according to the fourth aspect of the invention, and

FIG. 6 is a schematic perspective view of a second embodiment of the antenna arrangement according to the first aspect of the invention.

### DETAILED DESCRIPTION OF THE EMBODIMENTS

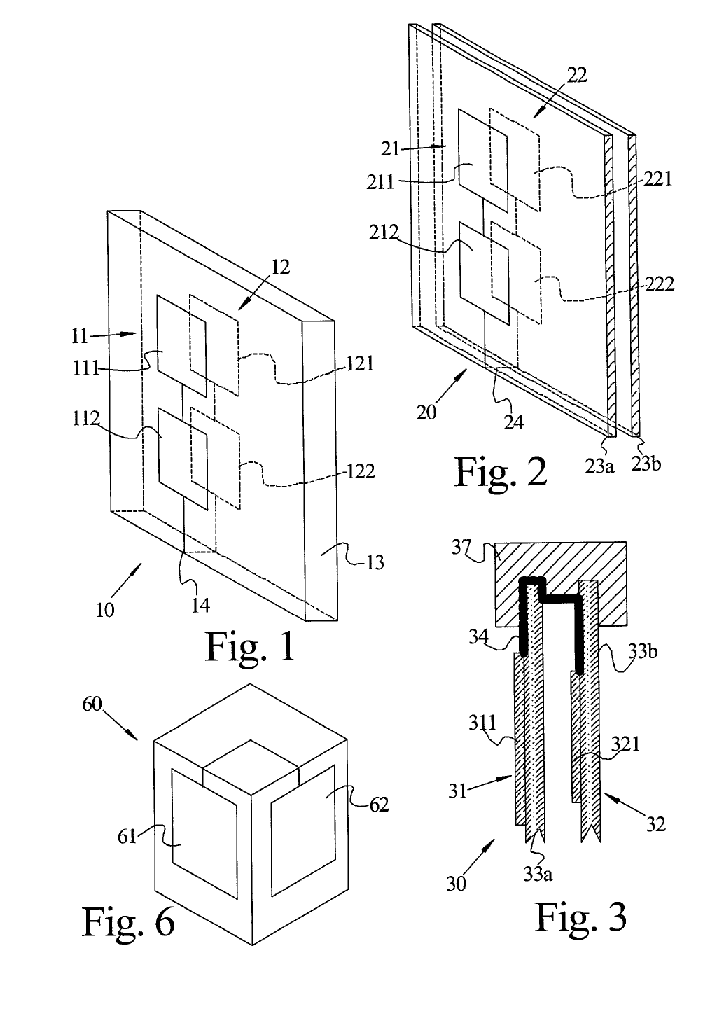

A simple design of the antenna arrangement 10, according to the present invention, is illustrated in FIG. 1. The antenna arrangement 10 consists of two parts, a first part 11 and a second part 12 arranged on opposite sides of a carrier 13. Each antenna part 11 and 12 comprises antenna elements, in this case configured as microstrips 111, 112 and 121, 122, respectively. The microstrips of each part are interconnected and each part is coupled through a connection 14. Thus, the antenna functions as a link antenna. The incoming radiation, e.g. received by elements 111 and 112 of the first part 11, is converted into electrical signals and transmitted to the second part 12, elements 121 and 122 of which are arranged to radiate on the other side of the carrier 13. The interconnection between the elements can be provided as a galvanic, capacitive or inductive connection. The antenna elements are resonant at a certain frequency. The elements are not supplied with external power but help to conduct the radiation past the carrier. The elements of each part have same shape. The advantage of using microstrip elements will be evident when describing one preferred manufacturing method here below.

The carrier can be a panel on a building, glass, signboard, etc., which usually deteriorates the passage of electromagnetic radiation. In the case where a wall panel of a building or a window glass is used as the carrier, the antenna links the radiation into and outside the building and provides for better indoor reception.

In the most preferred embodiment, as illustrated in FIG. 2, the antenna arrangement 20, comprising two parts, a first part 21 and a second part 22, is arranged on opposite sides of two carriers 23a and 23b made of glass or similar material. As in the forgoing example 10, each antenna part 21 and 22 comprises antenna elements 211, 212 and 221, 222, respectively. Each part is coupled through a connection 24.

Preferably, the glasses are part of a window, in particular a two-glass window. Advantageously, one part of the antenna arrangement can be arranged on the inner surface of one of the glasses, i.e. between the glasses. It is also possible to arrange the antenna on a three-glass window etc.

A cut through a part of a two-glass window is illustrated in FIG. 3. The glasses 33a and 33b are arranged in a frame 37, enabling a distinct distance between the glasses. In this case, the antenna element 311 belonging to one antenna part 31 of the antenna arrangement 30 is placed on the outer surface of the outer glass 33a and the antenna element 321 belonging to the other antenna part 32 is arranged on the outer surface of the inner glass 33b, i.e. in the space between the glasses. Moreover, the antenna elements have different sizes (or shapes) to be able to alter radiation characteristics. The antenna parts are inter-connected through a connection 34, which can comprise a conductive paste, a conductor or the like. If a three-glass window is used, the intermediate glass can be provided with a third layer of conductive coating arranged as a ground plane for the purpose of screening between the antenna parts.

The antenna elements may also be arranged on different sides of a carrier as illustrated in FIG. 6. In this example, the carrier 63 is cubical and antenna elements 61 and 62 are arranged on two adjacent sides. Thus, the arrangement redirects the radiation.

The advantageous result of above described antennas is that, particularly in urban environments, the effect of the base station transmitters can be reduced as the power required for penetrating through obstacles, such as windows and walls will be reduced. Also, the receiving features for satellite transmissions are improved as the walls or the like, surrounding a compartment or room, will no longer be significant obstacles a.

The antenna element material can consist of any conductive material. However, the antenna elements applied on a window glass should be made of a thin and light preamble conductive film. The antenna element pattern can be adapted to a determined frequency. Also, the distance between the antenna parts, i.e. the distance between the glass surfaces can be adapted such that the desired performance can be obtained. Parameters like the size, form and distance between the antenna elements are frequency specific, i.e. the received and radiated frequencies can be specified and changed by changing the mentioned parameters.

This passive antenna design is suitable for high frequency applications, where the glass normally suppresses the radiation. The external antenna elements can be deigned to direct the antenna lobe, e.g. towards a base station antenna. The antenna elements can also be formed as a group antenna, which provides increased amplification resulting in less required transmission power from the base station and an indoor terminal and allowing better coverage.

As mentioned above, when a window is used as the support structure for the antenna, it is desired that the antenna elements do not deteriorate the light permeability (thus the function of the window). In the most preferred embodiment of the invention, the antenna elements are provided as a thin, conductive, light preamble coating. Preferably, the coating is applied through sputtering, spraying or the like on the glasses. A termination paste can be applied on the edges of the glass or at the inter-connection positions. Then the paste is cured through heating. The conductive coating may consist of any conductive material, preferably silver, gold, stannic oxide or the like can be used. The antenna elements can be shaped (size and/or form) through selective coating or cut out by means of a laser beam. The coating can be provided with a protective layer, e.g. by providing a glass laminate.

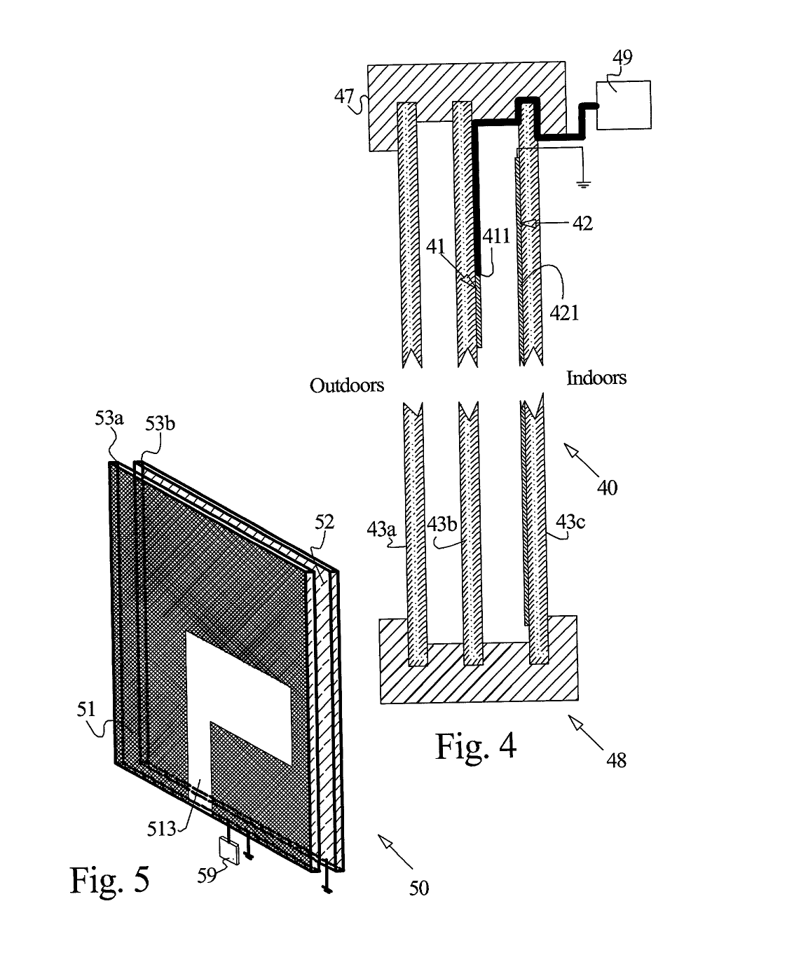

The above-described manufacturing method enables the arrangement of active antennas on a glass or silicon carrier as well. FIG. 4 illustrates a cut through a three-glass window 48 comprising a frame 47 framing three glasses 43a-43c. The antenna arrangement 40 comprises a first portion 41 and a second portion 42. The first portion 41 comprises at least one antenna element 411 arranged as the radiator on the inner surface of the intermediate glass 43b and the second portion 42 comprises a ground plane 421 arranged on outer surface of the inner glass 43c. The radiator 411 is connected to a transceiver circuit 49 of a communication device (not shown). Thus, the antenna arrangement functions as an active antenna converting input signal from the transceiver circuit to electromagnetic radiation and incident electromagnetic radiation to electrical signals.

Another example of the active antenna is shown in FIG. 5. The antenna arrangement 50 is a ground plane dependent antenna, such as a PIFA (Planar Inverted-F Antenna). A first glass 53a is provided with a conductive coating acting as the radiator element 51 and the second glass 53b is provided with a ground plane. The conductive layer is arranged with a non-conductive gap 513, which allows the antenna to function as a dual band antenna. The gap is produced by selective sputtering/spraying or cut out by means of a laser beam. The radiator is connected to a transceiver circuit 59 by means of feed connection and to the ground by means of a ground connection.

The invention is not limited to the shown embodiments but can be varied in a number of ways without departing from the scope of the appended claims and the arrangement and the method can be implemented in various ways depending on application, functional units, needs and requirements etc. Thus, the shape and number of the radiators and their position is not limited to the illustrated examples and other alternatives can occur

What we claim is:

1. An antenna arrangement comprising a first portion and a second portion, each portion being arranged spaced apart and on first and second sides of at least one carrier structure, each of said first and second portions comprising at least one antenna element, said antenna elements of each antenna portion being electrically connected and the antenna element of said first portion is arranged to transmit an incident electromagnetic radiation on said first side of said carrier in form of an electrical signal to the antenna element of said second portion on said second side of said carrier, which antenna element of said second portion is arranged to transform and radiate the electrical signal from the second side of the carrier, wherein each antenna element comprises a thin layer of a conductive coating arranged on at least part of surface of said carrier.

2. The antenna arrangement of claim 1, wherein said carrier structure comprises at least two glasses in a two-glass window.

3. The antenna arrangement of claim 2, wherein said antenna elements are arranged on the surfaces of each glass.

4. The antenna arrangement of claim 2, wherein each antenna element on each glass has different characteristics.

5. The antenna arrangement of claim 1, wherein said carrier structure is glasses of a three-glass window.

6. The antenna arrangement of claim 5, wherein an intermediate glass is provided with a ground plane and inner and outer glasses are arranged with antenna elements.

7. The antenna arrangement according claim 6, wherein each antenna element has a pattern, which can be adapted to a desired frequency.

8. The antenna arrangement according to claim 1, wherein said distance between the antenna parts is adapted such that a desired performance for a special frequency(ies) is obtained.

9. The antenna arrangement according to claim 1, wherein an externally arranged antenna element is designed to direct an antenna lobe to a radiation source

10. The antenna arrangement according to claim 2, wherein the antenna elements are formed as a group antenna for providing increased amplification.

11. The antenna arrangement according to claim 1, wherein said antenna arrangement constitutes a Planar Inverted-F Antenna (PIFA), wherein one antenna element at one side of said carrier is arranged as a radiating element (51) and another element at the other side of the carrier is arranged as a ground plane.

12. The antenna arrangement according to claim 1, wherein said thin conductive layer is arranged as a microstrip.

13. The antenna arrangement according to claim 1, wherein at least one of said elements is substantially light preamble.

14. A method of manufacturing an antenna arrangement comprising a first portion and a second portion, each portion being arranged spaced apart and on first and second sides of at least one carrier structure, each of said first and second portions comprising at least one antenna element, said antenna elements of each antenna portion being electrically connected and the antenna element of said first portion is arranged to transmit an incident electromagnetic radiation on said first side of said carrier in form of an electrical signal to the antenna element of said second portion on said second side of said carrier, which antenna element of said second portion is arranged to transform and radiate the electrical signal from the second side of the carrier, wherein each antenna element comprises a thin layer of a conductive coating, the method comprising arranging a substantially light permeable and conductive coating on at least part of said carrier, and arranging a galvanic connection to said coating.

15. The method of claim 14, wherein said coating is arranged with a shape or size by selective coating.

16. The method of claim 14, wherein said coating is arranged with a shape or size by cutting out a section by means of a laser beam.

17. The method according to claim 16, wherein said coating is provided through spraying or sputtering.
